(19) United States
(12) Patent Application Publication
(10) Pub. No.: US 2012/0289449 A1
(43) Pub. Date: Nov. 15, 2012

(54) LIQUID DETERGENT FORMULATION CONTAINING PEROXIDE, A PEROXIDE STABILIZER, AND A METAL-BASED CATALYST

(75) Inventor: Steven T. ADAMY, Lawrenceville, NJ (US)

(73) Assignee: CHURCH & DWIGHT CO., INC., Princeton, NJ (US)

(21) Appl. No.: 13/104,113

(22) Filed: May 10, 2011

(51) Int. Cl. C11D 3/60; C11D 7/60

(52) U.S. Cl. 510/372

(57) ABSTRACT

The invention is an aqueous formulation containing a peroxy component, a peroxide stabilizer comprising a quaternary alkylamino pyridyl compound, and a bleaching catalyst.

### FIELD OF THE INVENTION

This invention relates to liquid cleaning detergent compositions containing peroxide, a peroxide stabilizer, and a catalyst.

### BACKGROUND

Hydrogen peroxide solutions have been used for many years for a variety of purposes, including bleaching, disinfecting, and cleaning a variety of things and surfaces ranging from skin, hair, and mucous membranes to contact lenses to household and industrial surfaces and instruments. In particular, peroxide-containing bleaching agents have long been used in washing and cleaning processes. When soiled clothing is contacted with such bleaching compositions, usually by washing the soiled clothing in the presence of the bleaching composition at the boil, the bleaching agent functions to remove such common domestic stains as tea, coffee, fruit and wine stains from clothing.

Traditionally, to clean a substrate such as clothing, the substrate is subjected to hydrogen peroxide, or to substances which can generate hydroperoxyl radicals, such as inorganic or organic peroxides. To be effective these peroxide systems must contain a sufficient amount of peroxide to work properly. However, over time the amount of peroxide in cleaning compositions can decrease as a function of time.

One method of stabilizing peroxide includes the use of quaternary ammonium compounds. For example, Japanese Patent Number 2007106903 discloses a liquid bleaching detergent composition containing a quaternary ammonium salt to stabilize hydrogen peroxide. The quaternary ammonium salt is present in 0.1 to 10 mass % expressed with a general formula:

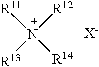

One or 2 of R¹¹, R¹², R¹³, and R¹⁴ are the aliphatic hydrocarbon groups of a straight chain of a hydrocarbon group or the carbon numbers 8-36, or branched chain which have one phenyl group, and the remainder is an alkyl group of a straight chain of the carbon numbers 1-5, or branched chain. However, a total carbon number of R¹¹, R¹², R¹³, and R¹⁴ is 19 or more. X⁻ is halogen ion or the alkyl-sulfuric-acid ion of the carbon numbers 1-3.

Japanese Patent Number 7216397 discloses a liquid bleaching detergent composition containing a quaternary ammonium salt to stabilize hydrogen peroxide. The quaternary ammonium salt is present in 0.5 to 20 mass % such as expressed with a general formula:

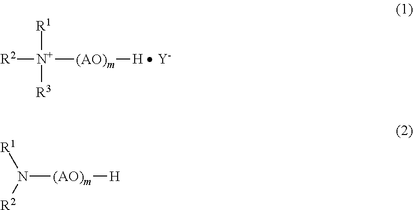

With respect to the above formulas of Japanese Patent Number 7216397:

R¹: The aryl group which showed the alkyl group or alkenyl group of the carbon numbers 1-20 of a straight chain or branched chain, or was replaced by the alkyl group of the carbon numbers 1-7 is shown, or benzyl is shown.

R²: A basis which shows an aryl group which could show an alkyl group or an alkenyl group of the carbon numbers 1-5, or may be replaced by an alkyl group of the carbon numbers 1-7, or is expressed with -(AO)ₙ—H as shown.

R³: A basis which shows an aryl group which could show an alkyl group or an alkenyl group of the carbon numbers 1-5, or may be replaced by an alkyl group of the carbon numbers 1-7, or is expressed with -(AO)ₚ—H is shown. A basis and p which define A by later here show the number of 2-30.

A: an alkylene group of the carbon numbers 2-3.

M: integer number of 2-30.

Y⁻: A negative ion group is shown.

Korean Patent Application Number 20050004309 discloses a bleach composition is provided to maximize the bleach activation of a quaternary ammonium derivative compound having excellent storage stability and self-sterilizing power and thus to show more excellent bleaching and sterilizing effects. The oxygen-based bleach composition containing inorganic peroxide comprises a quaternary ammonium derivative compound as a bleaching activator, represented by the formula immediately below and an anionic surfactant in a ratio of 100:1 to 2:1.

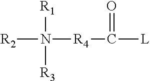

In the formula immediately above, each of R1 and R2 is independently any one selected from the group consisting of C1-C3 alkyl, aryl, alkenyl, hydroxyalkyl and alkarylene, R3 is any one selected from the group consisting of C1-C20 alkyl, aryl, alkenyl, hydroxyalkyl and alkarylene, R4 is any one selected from the group consisting of C1-C5 alkyl, aryl, alkenyl, hydroxyalkyl and alkarylene, and L is any one leaving group selected from the group consisting of radicals represented by the formulas I through IV shown immediately below. The anionic surfactant is at least one selected from a linear alkylbenzenesulfonate, a fatty acid salt, an alkenesulfonate and -olefinsulfonate.

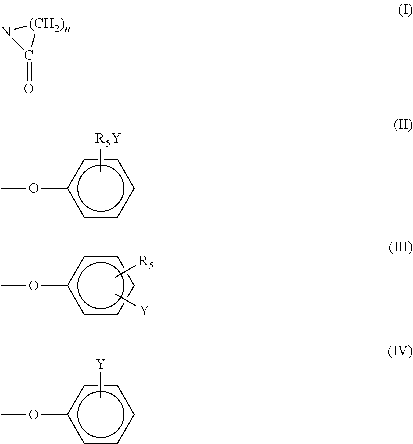

Korean Patent Number 20050005676 discloses a bleaching detergent composition having an excellent shelf stability, wherein the detergent contains an inorganic peroxide and comprises 0.01-15 wt % of a quaternary ammonium derivative-based bleaching activator compound represented by the following formula and 0.1-40 wt % of a non-ionic surfactant based on the total weight of the composition.

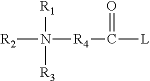

Still referring to Korean Patent Number 20050005676, each of R1 and R3 is any one independently selected from the group consisting of a C1-C3 alkyl, aryl, alkenyl, hydroxyalkyl and alkarylene; R2 is any one selected from the group consisting of a C1-C20 alkyl, aryl, alkenyl, hydroxyalkyl and alkarylene; R4 is any one selected from the group consisting of a C1-C5 alkyl, aryl, alkenyl, hydroxyalkyl and alkarylene; L is a selected leaving group; and Z— is any one selected from the group consisting of Cl—, Br—, OH—, citrate, acetate, sulfate, borate and phosphate.

Japanese Patent Number 2002356313 discloses a method of stabilizing hydrogen peroxide in the application of printed-circuit boards and liquid crystals. Stabilized hydrogen peroxide is produced by adding a quaternary ammonium salt as a stabilizer. The mole ratio of hydrogen peroxide/quaternary ammonium salt is 0.01-10.

U.S. Patent Publication Number 20060110348 discloses a therapeutic composition for treating a skin disorder. The composition comprises a cationic organosilane quaternary ammonium compound and hydrogen peroxide in aqueous media. In one embodiment the quaternary compound is present in an amount up to about 5% by weight and hydrogen peroxide is present in an amount up to about 20% by weight. In another embodiment the quaternary compound is present in an amount of about 1 to 5% by weight and hydrogen peroxide is present in an amount of about 3 to about 10% by weight. The composition may include a solvent selected from the group of an alcohol, polyol, glycolether and mixtures thereof. The polyol or alcohol can be a glycol, ethylene glycol monobutyl ether, methanol, ethanol or isopropanol. The composition can have a pH of about 2 to about 5, and preferably about 3 to 5.

U.S. Pat. No. 7,704,313 describes a surfactant-free cleansing and multifunctional liquid coating composition containing an organosilane quaternary compound, nonreactive abrasives, and hydrogen peroxide in aqueous formulations are used to improve water and soil repellency and residual antimicrobial activity on surfaces.

U.S. Patent Publication Number 20080175801 relates to stable personal care composition, including oral care compositions containing a peroxide source. The compositions are stabilized by eliminating or minimizing the presence in the composition of metals having radical forming potential with the peroxide. Preferably, the metals that are eliminated or reduced are cobalt, copper, palladium, nickel and iron. The compositions are further stabilized by the addition of agents having scavenging or quenching activity for free radicals. Reducing free radical activity in the product matrix prevents radical-mediated loss and degradation of peroxide and other ingredients, in particular organic compounds added as active or aesthetic agents, including flavors, perfumes, colorants and thickeners. Provided are peroxide containing oral care products with enhanced consumer appeal in terms of taste, mouth-feel and appearance, thereby encouraging compliance and regular use. Such attributes are important since use of these products may involve fairly long residence time in the mouth for efficacy.

### SUMMARY OF THE INVENTION

The invention is a stable aqueous formulation containing a peroxy bleaching component, a peroxide stabilizer comprising a quaternary alkylamino pyridyl compound, and a metal bleach catalyst.

### BRIEF DESCRIPTION OF THE DRAWINGS

FIG. 1 shows plots of H₂O₂ level expressed as a percentage of initial level as a function of time for seven samples with different mole fractions of CPC in CPC+Tomadol in cleaning compositions having a metal catalyst.

FIG. 2 shows plots of H₂O₂ level levels expressed as percentage of initial levels as functions of time.

FIG. 3 shows plots of levels of peroxide at day 84 as a function of CPC mole fraction.

FIG. 4 shows peroxide levels (% of original) for systems with CG 50 HP and either Tomadol or CPC only as a function of time.

FIG. 5 shows plots of H₂O₂ levels expressed as percentage of initial levels as functions of time for systems with either CPC or DTAC.

### DETAILED DESCRIPTION OF THE INVENTION

The invention is an aqueous formulation containing a peroxy bleaching agent, a peroxide stabilizer, and a peroxide bleach catalyst. The peroxide stabilizer comprises a quaternary alkylamino pyridyl functional group such as, but not limited to, cetylpyridinium chloride (CPC) and the peroxide catalyst may comprise a metal ion such as a manganese ion.

Though incorporation of a catalyst with a peroxide-based bleaching agent is common for solid systems, it is extremely difficult to maintain peroxide levels in liquid systems containing a peroxide catalyst. The reason liquid systems do not contain both peroxide and peroxide catalyst is that in solution, the catalyst causes the degradation of the peroxide through a series of reactions:

M_{red}+H₂O₂→Mₒₓ+.OH+OH⁻

M_{red}+.OH→Mₒₓ+OH⁻

H₂O₂+.OH→OOH+H₂O

M_{red}+.OOH→Mₒₓ+HOO⁻

Mₒₓ+.OOH→M_{red}+H+O₂

where M_{red} and Mₒₓ are the reduced and oxidized forms of the metal ion, respectively. Other authors report slightly different mechanisms. (see M. Lewin, in Ch. 2 of Chemical Processing of Fibers and Fabrics, Fundamentals and Preparation, Part B, M. Lewin and S. B. Sello (ed.), Marcel Dekker, Inc., New York, 1984, pp. 178-79).

It is believed that there are no liquid cleaning detergents or agents that comprise a combination of peroxide, a peroxide stabilizer, and a peroxide catalyst in a single liquid system as taught by the present invention.

### Catalyst

Certain heavy metals, or complexes thereof, function to catalyze the decomposition of hydrogen peroxide, or of compounds which are capable of liberating hydrogen peroxide, in order to render the peroxide compound effective at temperatures below 60° C.

The compositions of the present invention comprise a metal-containing bleach catalyst. One type of metal-containing bleach catalyst is a catalyst system comprising a transition metal cation of defined bleach catalytic activity, such as but not limited to: copper, iron, nickel, chromium, titanium, ruthenium tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, (methylenephosphonic acid) and water-soluble salts thereof. Such catalysts are disclosed in U.S. Pat. No. 4,430,243.

Other types of bleach catalysts include the manganese-based complexes disclosed in U.S. Pat. No. 5,246,621 and U.S. Pat. No. 5,244,594. Preferred examples of these catalysts include Mn^{IV}₂ (u-O)₃(1,4,7-trimethyl-1,4,7-triazacyclononane)₂-(PF₆)₂ (“MnTACN”), Mn^{III}₂(u-O)₁(u-OAc)₂(1,4,7-trimethyl-1,4,7-triazacyclononane)₂-(ClO₄)₂, Mn^{IV}₄(u-O)₆(1,4,7-triazacyclononane)₂-(ClO₄)₂, Mn^{III}Mn^{IV}₄(u-O)₁(u-OAc)₂-(1,4,7-trimethyl-1,4,7-triazacyclononane)₂-(ClO₄)₃, and mixtures thereof. See also European patent application publication no. 549,272. Other ligands suitable for use herein include 1,5,9-trimethyl-1,5,9-triazacyclododecane, 2-methyl-1,4,7-triazacyclononane, 2-methyl-1,4,7-triazacyclononane, and mixtures thereof.

Bleach catalysts of particular use in automatic dishwashing compositions and concentrated powder detergent compositions may also be selected as appropriate for the present invention. For examples of suitable bleach catalysts see U.S. Pat. No. 4,246,612 and U.S. Pat. No. 5,227,084. See also U.S. Pat. No. 5,194,416 which teaches mononuclear manganese (IV) complexes such as Mn(1,4,7-trimethyl-1,4,7-triazacyclononane(OCH₃)₃—(PF₆).

Still another type of bleach catalyst, as disclosed in U.S. Pat. No. 5,114,606, is a water-soluble complex of manganese (II), (III), and/or (IV) with a ligand which is a non-carboxylate polyhydroxy compound having at least three consecutive C——OH groups. Preferred ligands include sorbitol, iditol, dulsitol, mannitol, xylitol, arabitol, adonitol, meso-erythritol, meso-inositol, lactose, and mixtures thereof.

Catalysts useful in the present invention include metal-containing catalysts such as, but not limited to, Tinocat® TRS KB2 (BASF), which is composed of a manganese ion complexed to three Schiff base ligands as shown below:

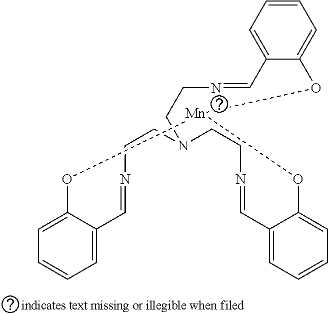

U.S. Pat. No. 5,114,611 teaches a bleach catalyst comprising a complex of transition metals, including Mn, Co, Fe, or Cu, with a non-(macro)-cyclic ligand. Said ligands are of the formula:

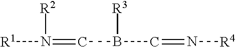

wherein R¹, R², R³, and R⁴ can each be selected from H, substituted alkyl and aryl groups such that each R¹———N═══C———R² and R³———C═══N———R⁴ form a five or six-membered ring. Said ring can further be substituted. B is a bridging group selected from O, S, CR⁵R⁶, NR⁷ and C═══O, wherein R⁵, R⁶, and R⁷ can each be H, alkyl, or aryl groups, including substituted or unsubstituted groups. Preferred ligands include pyridine, pyridazine, pyrimidine, pyrazine, imidazole, pyrazole, and triazole rings. Optionally, said rings may be substituted with substituents such as alkyl, aryl, alkoxy, halide, and nitro. Particularly preferred is the ligand 2,2′-bispyridylamine. Preferred bleach catalysts include Co, Cu, Mn, Fe, -bispyridylmethane and -bispyridylamine complexes. Highly preferred catalysts include Co(2,2′-bispyridylamine)Cl₂, Di(isothiocyanato)bispyridylamine-cobalt (II), trisdipyridylamine-cobalt(II) perchlorate, Co(2,2-bispyridylamine)₂O₂ClO₄, Bis-(2,2′-bispyridylamine) copper(II) perchlorate, tris(di-2-pyridylamine) iron(II) perchlorate, and mixtures thereof.

Other examples include Mn gluconate, Mn(CF₃SO₃)₂, Co(NH₃)₅Cl, and the binuclear Mn complexed with tetra-N-dentate and bi-N-dentate ligands, including N₄Mn^{III}(u-O)₂Mn^{IV}N⁴)⁺ and [Bipy₂Mn^{III}(u-O)₂Mn^{IV}bipy₂]-(ClO₄)₃.

The bleach catalysts may also be prepared by combining a water-soluble ligand with a water-soluble manganese salt in aqueous media and concentrating the resulting mixture by evaporation. Any convenient water-soluble salt of manganese can be used herein. Manganese (II), (III), (IV) and/or (V) is readily available on a commercial scale.

Other bleach catalysts are described, for example, in European patent application, publication no. 408,131 (cobalt complex catalysts), European patent applications, publication nos. 384,503, and 306,089 (metallo-porphyrin catalysts), U.S. Pat. No. 4,728,455 (manganese/multidentate ligand catalyst), U.S. Pat. No. 4,711,748 and European patent application, publication no. 224,952, (absorbed manganese on aluminosilicate catalyst), U.S. Pat. No. 4,601,845 (aluminosilicate support with manganese and zinc or magnesium salt), U.S. Pat. No. 4,626,373 (manganese/ligand catalyst), U.S. Pat. No. 4,119,557 (ferric complex catalyst), German Pat. specification 2,054,019 (cobalt chelant catalyst) Canadian 866,191 (transition metal-containing salts), U.S. Pat. No. 4,430,243 (chelants with manganese cations and non-catalytic metal cations), and U.S. Pat. No. 4,728,455 (manganese gluconate catalysts).

Another example of a metal catalyst suitable for the present invention is described in U.S. Pat. No. 6,528,469. U.S. Pat. No. 6,528,469 describes certain other manganese compounds that are also excellent bleach catalysts for peroxy compounds and, relative to known bleach catalysts, provide enhanced bleach effects at low wash temperatures (e.g. at 15 to 40° C.) and/or using shorter washing times. The peroxy compounds may be produced by known methods, e.g. by the methods analogous to those disclosed in U.S. Pat. No. 4,655,785 relating to similar copper compounds.

Other catalysts, such as Fe, Ni, Cr, Cu, etc. could be employed. In addition, U.S. Pat. No. 6,093,343 describes various cobolt catalysts that could be used in the present invention.

In practical terms for current commercial preparations, typical amounts of catalyst used in the present invention are typically from 0.2% to 5%, preferably 0.25% to 0.75%, by weight of a commercial detergent preparation, and most preferably at about 0.50% by weight of a commercial detergent preparation.

### Bleaching Agent

The peroxy component of the bleach compositions used in the present invention may be hydrogen peroxide, a compound which liberates hydrogen peroxide, a peroxyacid, a peroxyacid bleach precursor or a mixture thereof.

Compounds which liberate hydrogen peroxide include, e.g., inorganic compounds such as alkali metal peroxides, -perborates, -percarbonates, -perphosphates and -persulfates and organic compounds such as peroxylauric acid, peroxybenzoic acid, 1,12-diperoxydodecanoic acid, diperoxyisophthalic acid and urea peroxide, as well as mixtures thereof. Sodium percarbonate and sodium perborate, in particular sodium perborate monohydrate, are preferred.

Peroxyacid compounds and peroxyacid bleach precursors are described in the above-mentioned U.S. Pat. No. 5,114,606, which is incorporated by reference herein in its entirety.

The preferred bleaching agents employed for the present invention are classified broadly as oxygen bleaches. The oxygen bleaches are represented by percompounds which are true per salts or ones which liberate hydrogen peroxide in solution. Preferred examples include sodium and potassium perphosphates, perborates, percarbonates, and monopersulfates.

In addition, hydrogen peroxide may be used in the present invention. Hydrogen peroxide is typically employed as a concentrated aqueous solution, such as Arkema peroxide CG 50-HP or Akzo PB33. Commercial grades also typically employ a number of ingredients to maintain stability, such as stannates, phosphonates, or additional chelants. The pH levels of these commercial grade peroxides are typically kept below 3 in order to further maintain improved stability.

In practical terms for current commercial preparations, typical amounts of the peroxy compound are typically from 0.5% to 12%, preferably 0.5-6%, of hydrogen peroxide of a commercial detergent preparation. Peroxide generating salts would be used at levels that could generate these amounts, so long as the use of such amounts is possible without promoting formula instability.

### Surfactants

The bleach compositions of the present invention may contain at least one anionic or nonionic surfactant or a mixture of the two types of surfactant. One or more nonionic surfactants may be included in the detergent of the present invention. Suitable nonionic surfactant compounds may fall into several different chemical types. Preferred nonionic surfactants are polyoxyethylene or polyoxypropylene condensates of organic compounds. Examples of preferred nonionic surfactants are:
(a) Polyoxyethylene or polyoxypropylene condensates of aliphatic carboxylic acids, whether linear- or branched-chain and unsaturated or saturated, containing from about 8 to about 18 carbon atoms in the aliphatic chain and incorporating from 5 to about 50 ethylene oxide or propylene oxide units. Suitable carboxylic acids include “coconut” fatty acid (derived from coconut oil) which contains an average of about 12 carbon atoms, “tallow” fatty acid (derived from tallow-class fats) which contains an average of about 18 carbon atoms, palmitic acid, myristic acid, stearic acid and lauric acid;
(b) Polyoxyethylene or polyoxypropylene condensates of aliphatic alcohols, whether linear- or branched-chain and unsaturated or saturated, containing from about 8 to about 24 carbon atoms and incorporating from about 5 to about 50 ethylene oxide or propylene oxide units. Suitable alcohols include the “coconut” fatty alcohol (derived from coconut oil), “tallow” fatty alcohol (derived from the tallow-class fats), lauryl alcohol, myristyl alcohol, and oleyl alcohol.

For example, alcohol ethoxylate such as, but not limited to, Tomadol series surfactants are useful in the present invention such as, but not limited to, Tomadol 1-7, an alcohol ethoxylate that is a nonionic surfactant made from linear C11 alcohol with 7 moles (average) of ethylene oxide. The present invention is not limited to Tomadol 1-7. For example, other useful surfactants include, but are not limited to, Tomadol 1-3, Tomadol 1-5, Tomadol 1-73-B, and Tomadol 1-9. Tomadol series surfactants are registered trademarks.

The contemplated water soluble anionic detergent surfactants are the alkali metal (such as sodium and potassium) salts of the higher linear alkyl benzene sulfonates and the alkali metal salts of sulfated ethoxylated and unethoxylated fatty alcohols, and ethoxylated alkyl phenols. The particular salt will be suitably selected depending upon the particular formulation and the proportions therein.

The sodium alkybenzenesulfonate surfactant (LAS), if used in the composition of the present invention, preferably has a straight chain alkyl radical of average length of about 11 to 13 carbon atoms. Specific sulfated surfactants which can be used in the compositions of the present invention include sulfated ethoxylated and unethoxylated fatty alcohols, preferably linear primary or secondary monohydric alcohols with C₁₀-C₁₈, preferably C₁₂-C₁₆, alkyl groups and, if ethoxylated, on average about 1-15, preferably 3-12 moles of ethylene oxide (EO) per mole of alcohol, and sulfated ethoxylated alkylphenols with C₈-C₁₆ alkyl groups, preferably C₈-C₉ alkyl groups, and on average from 4-12 moles of EO per mole of alkyl phenol.

Anionic surfactants are well known to those skilled in the art. Typical anionic surfactants include sulfates and sulfonate salts, such as C₈ to C₁₂ alkylbenzene sulfonates, C₁₂ to C₁₆ alkane sulfonates, C₁₂ to C₁₆ alkyl sulfates, C₁₂ to C₁₆ alkylsulfosuccinates, and sulfates of ethoxylated and propoxylated alcohols, such as those described above. Typical anionic surfactants include, for example, sodium cetyl sulfate, sodium lauryl sulfate, sodium myristyl sulfate, sodium stearyl sulfate, sodium dodecylbenzene sulfonate, and sodium polyoxyethylene lauryl ether sulfate. Sodium lauryl (dodecyl) sulfate (SLS) is commonly used in cleaning agents.

In practical terms for current commercial preparations, typical amounts of surfactant used in the present invention are typically from 2% to 20%, preferably 5-15%, by weight of a commercial detergent preparation.

### Stabilizers and pH Buffers

The compositions of the present invention may also contain various additional stabilizers and/or pH buffers, especially borate-type stabilizers or pH buffers. Compounds such as boric acid, boric oxide, borax and other alkali metal borates (e.g., sodium ortho-, meta- and pyroborate, and sodium pentaborate) are suitable. Substituted boric acids (e.g., phenylboronic acid, butane boronic acid, and p-bromo phenylboronic acid) can also be used in place of boric acid.

In practical terms for current commercial preparations, typical amounts of stabilizers and/or pH buffers are typically from 0.1% to 10%, preferably 0.25-1%, by weight of a commercial detergent preparation.

A suitable peroxide stabilizer is one that contains a quaternary alkylamino pyridyl functional group. The alkyl group should contain at least 10 carbons. Non-limiting examples of stabilizers include cetylpyridinium chloride (e.g., Cetylpyridinium chloride monohydrate (Aldrich), CPC.H₂O, molecular weight: 358, Empirical Formula (Hill Notation): C21H38ClN.H₂O), shown below:

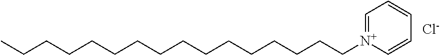

### Other Agents

The composition of the present invention may also, optionally, contain chelating agents, dye transfer inhibiting agents, dispersants, enzymes, enzyme stabilizers, polymeric dispersing agents, clay soil removal/anti-redeposition agents, brighteners, suds suppressors, dyes, perfumes, structure elasticizing agents, bleach activators, fabric softeners, carriers, hydrotropes, processing aids, solvents, pigments, hueing agents, structurants, and mixtures thereof.

### EXAMPLES

A series of formulations (see Table 1) were made containing the peroxide PB33® (Akzo Nobel), a 33% active form of H₂O₂ with improved alkaline pH stability. The peroxide stabilizer used was cetylpyridinium chloride monohydrate (Aldrich), i.e., CPC.H₂O. The catalyst used was the Tinocat® TRS KB2 (BASF), composed of a manganese ion complexed to three Schiff base ligands:

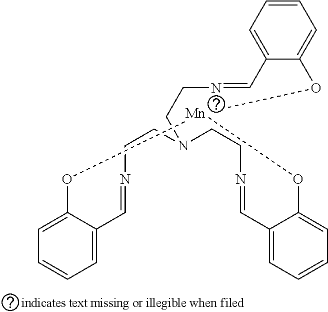

The compositions, except for formulation #7, also contained the surfactants Tomadol® 1-7 (7-mole ethoxylate undecyl alcohol, from Air Products). All the formulations, except for formulation #1 contained CPC.H₂O, see Table 1 below.

TABLE 1
Formulations of peroxide based cleaning agents

| | 1 | 2 | 3 | 4 | 5 | 6 | 7 |
|---|---|---|---|---|---|---|---|
| H₂O₂ (from | 1.00 | | | | | | |
| PB33) | | | | | | | |
| Tinocat TRS | 0.50 | | | | | | |
| KB2 | | | | | | | |
| CPC•H₂O | 0 | 1.26 | 2.21 | 3.15 | 4.10 | 5.04 | 6.3 |
| Tomadol 1-7 | 8.00 | 6.40 | 5.20 | 4.00 | 2.80 | 1.60 | 0 |

| Borax | 0.50 | | | | | | |
|---|---|---|---|---|---|---|---|
| Water | q.s. | | | | | | |
| Mole fraction of | 0 | 0.20 | 0.35 | 0.50 | 0.65 | 0.80 | 1.00 |
| CPC in | | | | | | | |
| CPC + Tomadol | | | | | | | |
| combination | | | | | | | |
| Initial pH | 7.8 | 7.2 | 7.1 | 6.9 | 6.9 | 6.6 | 6.6 |

Samples were evaluated via a permanganate titration 1 day following formulation and up to 84 days following formulation. Levels of H₂O₂ were determined through titration with 0.1 N KMnO₄ under acidic conditions. The oxidation of H₂O₂ by MnO₄⁻ is typically expressed through the reaction:

5H₂O₂(aq)+6H⁺(aq)+2MnO₄−→5O₂+2Mn²⁺(aq)+8H₂O

However, an equally acceptable balanced version is

H₂O₂(aq)+6H⁺(aq)+2MnO₄⁻→3O₂+2Mn²⁺(aq)+4H₂O

This equation was the relationship assumed in the calculations, and is consistent with other published methods (see American Chemical Society, Reagent Chemicals, Sixth Ed., American Chemical Society, Washington, D.C., 1981, pp. 287-88).

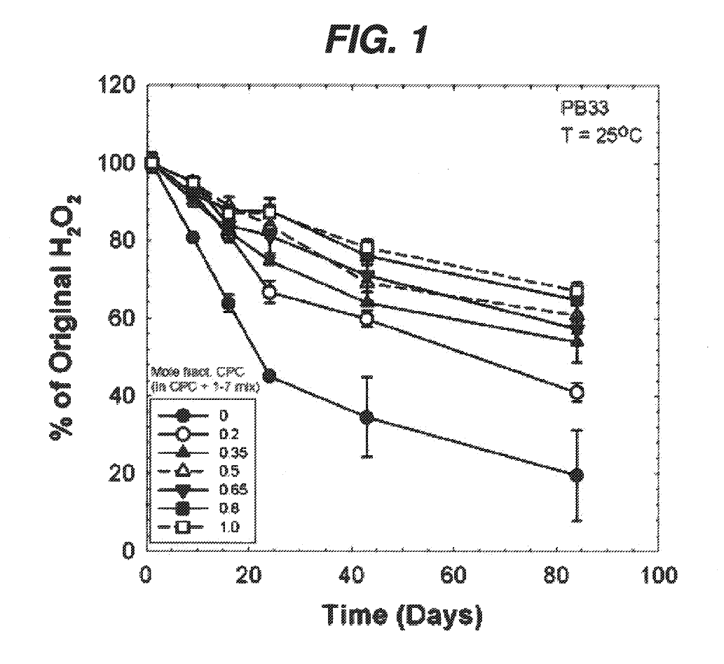

FIG. 1 show plots of peroxide level expressed as a percentage of initial level as a function of time over an 84 day period. The plots correspond to the formulations shown in Table 1. The plots show that compositions richer in CPC exhibited higher degrees of peroxide stability compared with those having lower amounts of CPC.

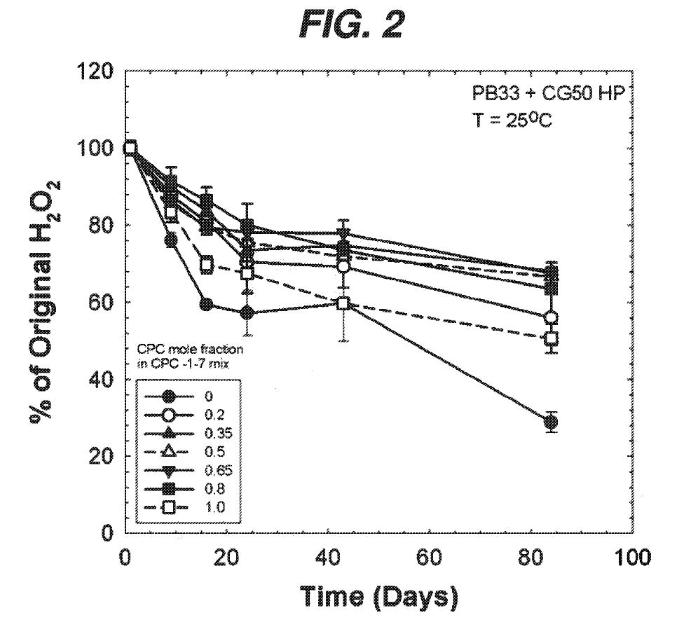

The formulations of Table 1 were remade but using 0.5% H₂O₂ from Akzo PB33 and 0.5% H₂O₂ from the Arkema peroxide CG50-HP. Peroxide levels expressed as percentage of initial levels as functions of time are shown in FIG. 2. The results with respect to FIGS. 1 and 2 show an unexpected and advantageous trend of higher peroxide stability associated with mole fractions of CPC in CPC+surfactant. In Table 1 the surfactant is represented by Tomadol 1-7. Specifically, mole fraction of CPC in CPC+Tomadol 1-7. It should be understood that the surfactant can vary. For example, other useful surfactants include, but are not limited to, Tomadol 1-3, Tomadol 1-5, Tomadol 1-73-B, and Tomadol 1-9.

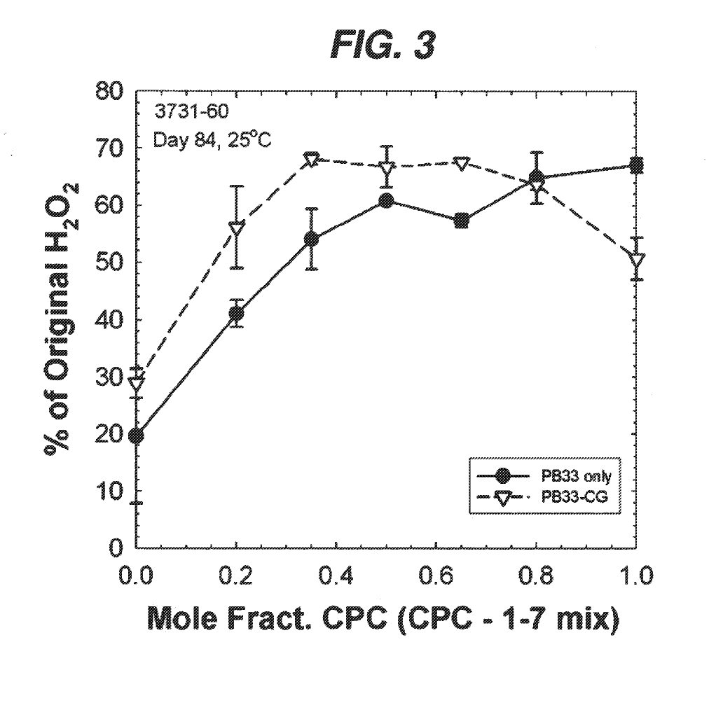

FIG. 3 further highlights the correlation between mole fraction of CPC and peroxide stability. Specifically, FIG. 3 shows plots of levels of peroxide at day 84 as a function of CPC mole fraction for systems employing only PB33 (from Table 1), and those employing both PB33 and CG50 HP (as described above). The plots in FIG. 3 indicate unexpected synergistic results with respect to mole fraction of CPC in CPC+surfactant (Tomadol 1-7) for systems employing the PB33-GC50 HP mix. Useful ranges for mole fraction of CPC in CPC+surfactant include: from 0.2 up to 1.0, from 0.2 up to 0.9, from 0.3 up to 0.8, from 0.3 up to 0.7, from 0.4 up to 0.8, from 0.35 up to 0.75 and from 0.4 up to 0.7; where synergistic activity is particularly found in the range from 0.35 up to 0.75, and more particularly in the range from 0.4 up to 0.7.

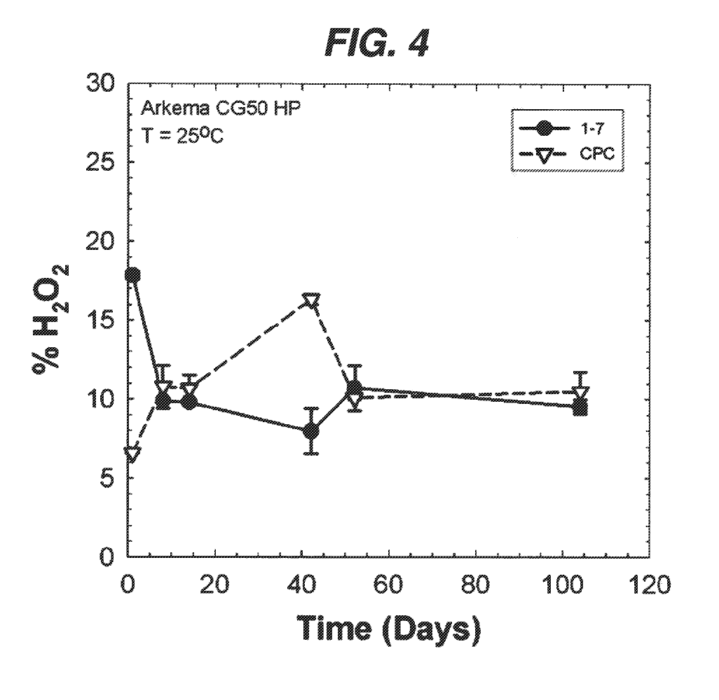

Two formulations were prepared corresponding to the formulations shown in Table 2 containing only Tomadol or CPC, and only Arkema CG 50 HP as the peroxide source. Both formulations exhibited poor stability as evidenced by the two corresponding plots shown in FIG. 4 which show peroxide levels (% of original) for systems with CG 50 HP and either Tomadol or CPC only as a function of time.

TABLE 2

| | With Tomadol 1-7 | Without Tomadol 1-7 |
|---|---|---|
| | Without CPC•1H₂O | With CPC•1H₂O |
| H₂O₂ (from CG50 HP) | 1.00 | 1.00 |
| Tinocat TRS KB2 | 0.50 | 0.50 |
| CPC•1H₂O | | 6.30 |
| Tomadol 1-7 | 8.00 | |
| Borax | 0.50 | 0.50 |
| Water | q.s. | q.s. |
| Initial pH | 7.9 | 8.8 |

Comparison of systems employing CPC and systems employing dodecyl Trimethyl Ammonium Chloride (DTAC).

Additional data is provided on the stability of peroxide/catalyst systems incorporating DTAC:

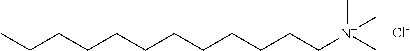

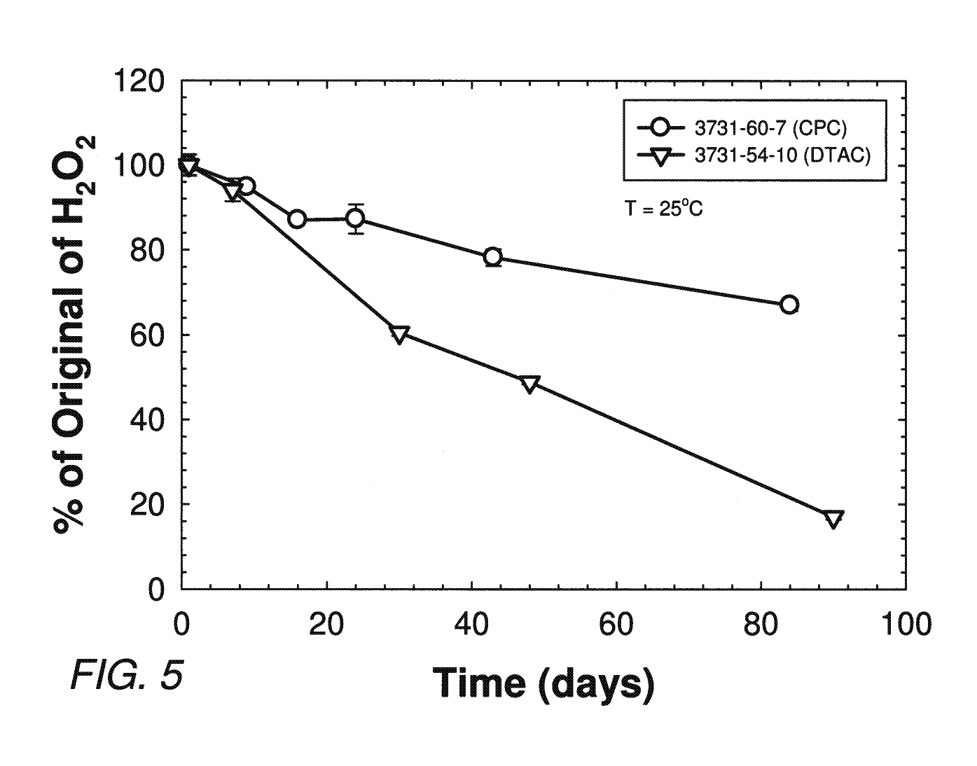

Data for the DTAC systems is compared with CPC (see Table 3 and FIG. 5).

TABLE 3

| | with CPC | with DTAC |
|---|---|---|
| H₂O₂ (from PB33 - Akzo | 1.00 | 1.00 |
| Nobel) | | |
| Tinocat TRS KB2 (Mn- | 0.50 | 0.50 |
| catalyst) | | |
| CPC•1H₂O | 6.30 | |
| DTAC | | 4.64 |
| Borax (Na₂B₄O₇•10H₂O) | 0.50 | |
| Water | q.s. | q.s. |

Peroxide levels were measured in each sample shown in Table 3 versus time as (see FIG. 5). The plots in FIG. 5 show that the system incorporating CPC displayed a higher degree of stability than that containing DTAC.

1. A liquid cleaning composition comprising:
a) a peroxy component;
b) a metal-containing bleach catalyst wherein the metal is selected from the group consisting of transition metals and heavy metals;
c) a peroxide stabilizer comprising a quaternary alkylamino pyridyl compound, wherein said alkyl group contains at least 10 carbon atoms; and
d) water.

2. The composition of claim 1, wherein the peroxy component is hydrogen peroxide.

3. The composition of claim 2, wherein the catalyst comprises a manganese cation.

4. The composition of claim 1, further comprising a surfactant.

5. The composition of claim 4, wherein the mole fraction of peroxide stabilizer with respect to stabilizer+surfactant is in the range from 0.2 up to 1.0.

6. The composition of claim 5, wherein the mole fraction of peroxide stabilizer with respect to stabilizer+surfactant is in the range from 0.2 up to 0.9.

7. The composition of claim 6, wherein the mole fraction of peroxide stabilizer with respect to stabilizer+surfactant is in the range of 0.3 up to 0.8.

8. The composition of claim 1, wherein the stabilizer is a cetylpyridinium compound.

9. The composition of claim 8, wherein the stabilizer is a cetylpyridinium chloride monohydrate.

10. The composition of claim 3, wherein the stabilizer is a cetylpyridinium compound.

11. The composition of claim 10, wherein the stabilizer is a cetylpyridinium chloride monohydrate.

12. The composition of claim 4, wherein said surfactant is a nonionic surfactant.

13. The composition of claim 12, wherein said nonionic surfactant is an alcohol ethoxylate.

14. The composition of claim 13, wherein said bleach catalyst comprises a manganese cation.

15. The composition of claim 14, wherein the stabilizer is a cetylpyridinium compound.

16. The composition of claim 15, wherein the stabilizer is a cetylpyridinium chloride monohydrate.

17. The composition of claim 13, wherein the mole fraction of peroxide stabilizer with respect to stabilizer+surfactant is in the range from 0.2 up to 1.0.

18. The composition of claim 5, wherein said peroxy component is hydrogen peroxide.

19. The composition of claim 11, wherein said peroxy component is hydrogen peroxide.

20. The composition of claim 16, wherein said peroxy component is hydrogen peroxide.
